(19) United States
(12) Patent Application Publication
(10) Pub. No.: US 2016/0173705 A1
(43) Pub. Date: Jun. 16, 2016

(54) TRANSMITTING HIGH-RESOLUTION IMAGES

(71) Applicant: Google Inc., Mountain View, CA (US)

(72) Inventor: Paul G. Nordstrom, Seattle, WA (US)

(73) Assignee: Google Inc., Mountain View, CA (US)

(21) Appl. No.: 14/141,316

(22) Filed: Dec. 26, 2013

Related U.S. Application Data
(60) Provisional application No. 61/829,942, filed on May 31, 2013.

(51) Int. Cl. H04N 1/00; G06F 3/00

(52) U.S. Cl. CPC H04N 1/00204; G06F 3/005

(57) ABSTRACT

Methods, systems, and apparatus, including computer programs encoded on a computer storage medium, for transmitting a video feed captured by a first video input device from a first user to a second user over a channel; determining, during the transmission, that criteria for providing a high-resolution image for display to the second user are satisfied; capturing the high-resolution image using the first video input device; and transmitting the high-resolution image over the channel to the second user as part of the video feed.

### CROSS-REFERENCE TO RELATED APPLICATION

This application claims priority to U.S. Provisional Application No. 61/829,942, filed on May 31, 2013. The disclosure of the prior application is considered part of and is incorporated by reference in the disclosure of this application.

### BACKGROUND

This specification relates to interactive environments that connect network-enabled communication devices. Various types of devices, e.g., desktop computers and mobile phones, can communicate with one another using various data communication networks, e.g., the Internet.

### SUMMARY

This specification describes technologies relating to providing interactive sessions. In general, a system transmits a video feed captured by a video input device from one user to another user over a communications channel, e.g., as part of an interactive session between the users. While the feed is being transmitted, the system can determine that a criterion for providing a high-resolution image to the second user is satisfied. The system can then capture a high-resolution image using the video input device and transmit image over the channel to the second user.

In general, one innovative aspect of the subject matter described in this specification can be embodied in methods that include the actions of transmitting a video feed captured by a first video input device from a first user to a second user over a channel; determining, during the transmission, that criteria for providing a high-resolution image for display to the second user are satisfied; capturing the high-resolution image using the first video input device; and transmitting the high-resolution image over the channel to the second user as part of the video feed. Other embodiments of this aspect include corresponding computer systems, apparatus, and computer programs recorded on one or more computer storage devices, each configured to perform the actions of the methods.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. Capturing the high-resolution image using the first video input device can include: copying a video frame captured by the first video input device as part of the video feed prior to the frame being compressed for transmission over the channel.

The video feed can be captured using a lower-resolution video mode of the first video input device, and capturing the high-resolution image using the first video input device can include: pausing the video mode; activating a higher-resolution still image mode of the video input device; capturing the high-resolution image using the still image mode; and resuming the video mode.

Determining that criteria for providing a high-resolution image are satisfied can include: determining that a predetermined time period has elapsed. Determining that criteria for providing a high-resolution image are satisfied can include analyzing video frames from the video feed. Determining that criteria for providing a high-resolution image are satisfied can include: receiving a request for a high-resolution image from a requesting user. The method can further include: in response to receiving the request, providing a user interface for display to the requesting user to enable the requesting user to specify an area of interest in a recently transmitted video frame.

Transmitting the high-resolution image over the channel to the second user as part of the video feed can include temporarily re-allocating a portion of the bandwidth of the channel previously allocated to the transmitting of the video feed to the transmitting of the high-resolution image.

The method can further include: receiving, at a user device of the second user and while receiving the transmitted video feed, an indication that transmission of the high-resolution image is commencing; and displaying the high-resolution image to the second user. Displaying the high-resolution image can include displaying the high-resolution image while displaying the video feed. Displaying the high-resolution image can include displaying the high-resolution image in place of the video feed.

In general, another innovative aspect of the subject matter described in this specification can be embodied in methods that include the actions of transmitting a video feed captured by a first video input device from a first user to a second user over a channel; determining, during the transmission, that criteria for capturing a high-resolution image are satisfied; capturing the high-resolution image using the first video camera; and transmitting the high-resolution image over the channel to the second user, wherein transmitting the high-resolution image comprises: stopping the transmitting of the video feed, transmitting the high-resolution image while the transmitting of the video feed is stopped, and resuming the transmitting of the video feed. Other embodiments of this aspect include corresponding computer systems, apparatus, and computer programs recorded on one or more computer storage devices, each configured to perform the actions of the methods.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. Capturing the high-resolution image using the first video input device can include: copying a video frame captured by the first video input device as part of the video feed prior to the frame being compressed for transmission over the channel. The video feed can be captured using a lower-resolution video mode of the first video input device, and capturing the high-resolution image using the first video input device can include: pausing the video mode; activating a higher-resolution still image mode of the video input device; capturing the high-resolution image using the still image mode; and resuming the video mode.

Determining that criteria for providing a high-resolution image are satisfied can include: determining that a predetermined time period has elapsed. Determining that criteria for providing a high-resolution image are satisfied can include analyzing video frames from the video feed. Determining that criteria for providing a high-resolution image are satisfied can include: receiving a request for a high-resolution image from a requesting user.

The method can further include: in response to receiving the request, providing a user interface for display to the requesting user to enable the requesting user to specify an area of interest in a recently transmitted video frame.

The method can further include: receiving, at a user device of the second user and while receiving the transmitted video feed, an indication that transmission of the high-resolution image is commencing; and displaying the high-resolution image to the second user. Displaying the high-resolution image can include displaying the high-resolution image while displaying the video feed. Displaying the high-resolution image can include displaying the high-resolution image in place of the video feed.

Particular embodiments of the subject matter described in this specification can be implemented so as to realize one or more of the following advantages. The user experience of participants in an interactive session can be enhanced by allowing the participants to view high-resolution still images captured using the video input device of another user. In particular, when it would be more desirable to view a high-resolution still image than a lower-resolution video feed or to view a high-resolution still image along with the lower-resolution video feed, a high-resolution image can be captured by the video input device being used to provide the video feed and transmitted for display to the other participants in the session. For example, participants in the session may be interested in viewing specific content shown on the video feed in more detail, e.g., a detailed drawing or a sketch drawn on a whiteboard by one of the participants. In order to allow the viewers to view the desired content, a high-resolution image showing the content can be captured and provided to the participants. As another example, one of the participants in the session may be interested in saving a particular scene being presented during the session for later use. In order to allow the participant to save the scene for later viewing or manipulation, a high-resolution image of the scene can be captured and provided to the participant.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example interactive session system.

FIG. 2 is a flow diagram of an example process for transmitting a high-resolution image.

FIG. 3 is a flow diagram of an example process for displaying a high-resolution image during a video feed.

Like reference numbers and designations in the various drawings indicate like elements.

### DETAILED DESCRIPTION

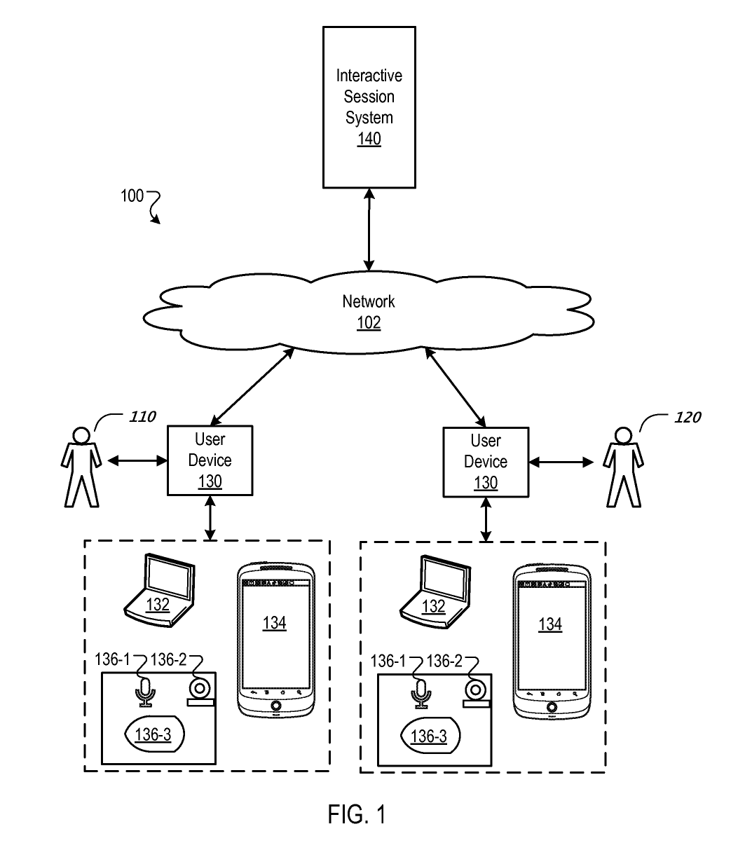

FIG. 1 shows an example interactive session system 140. The interactive session system 140 is an example of a system implemented as computer programs on one or more computers in one or more locations, in which the systems, components, and techniques described below can be implemented.

A user, e.g., users 110 or 120, can interact with the interactive session system 140 using a user device 130 through a data communication network 102. The network 102 enables data communication between multiple electronic devices. Users can access content, provide content, exchange information, and participate in interactive sessions by use of the devices and systems that can communicate with each other over the network 102. The network 102 can include, for example, a local area network (LAN), a cellular phone network, a wide area network (WAN), e.g., the Internet, or a combination of them. The links on the network can be wireline or wireless links or both.

A user device 130 is an electronic device, or collection of devices, that is capable of interacting with the interactive session system 140 over the network 102. Example user devices 130 include personal computers 132, mobile communication devices 134, and other devices that can send and receive data over the network 102. A user device 130 is typically configured with a user application, e.g., a web browser, that sends and receives data over the network 102, generally in response to user actions. The user application can enable a user to display and interact with text, images, videos, music and other content, which can be located on a web page on the World Wide Web or a local area network.

Generally, a user device 130 is a system that includes one or more of an audio input device 136-1, a video input device 136-2, a display device 136-3, and optionally other input devices, e.g., for text or gesture input.

The interactive session system 140 allows people to organize, request, and participate in interactive sessions. In an interactive session, a person interacts with another person, e.g., by viewing a video feed of video being captured by the video input device of the user device of the other person participating in the session. For example, the interactive session system 140 can allow the user 110 to interact with the user 120 as part of an interactive session. In some instances, one of the participants can act purely as an observer, i.e., information does not pass from the user device of the observer to the user devices of the other people participating in the session. For example, the interactive session system 140 can allow user 110 to view a video feed captured by the user device of the user 120 while acting as an observer. In other instances, however, each person can play an active role, and information goes in both directions during the session. For example, during the session, the interactive session system 140 can allow each of the users 110 and 120 to view video feeds captured by the user device of the other user. The term “interactive session” may thus refer to such an interaction, the period of interaction, or a recording of such an interaction, as the context requires.

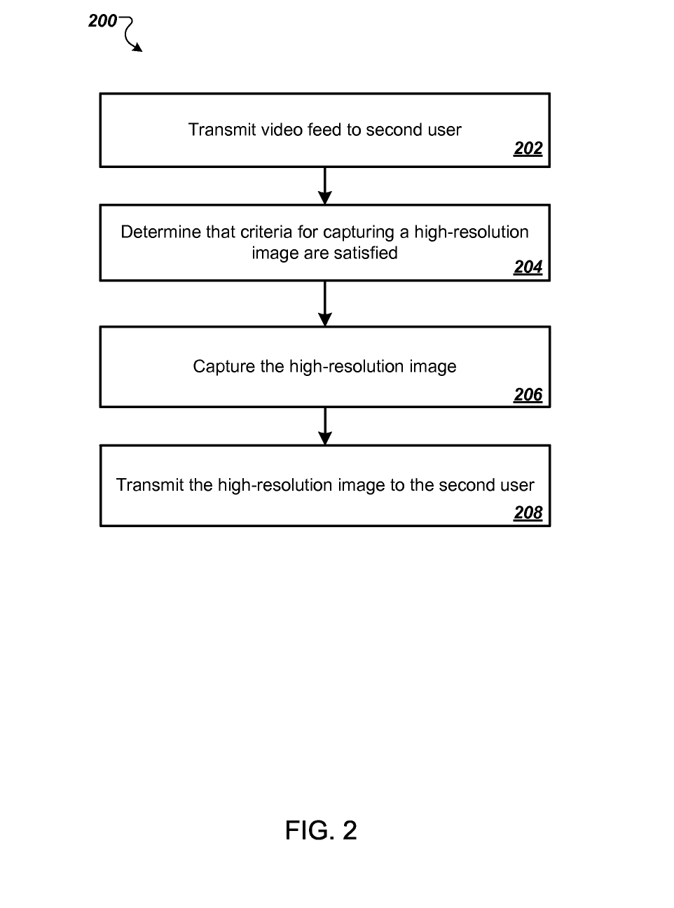

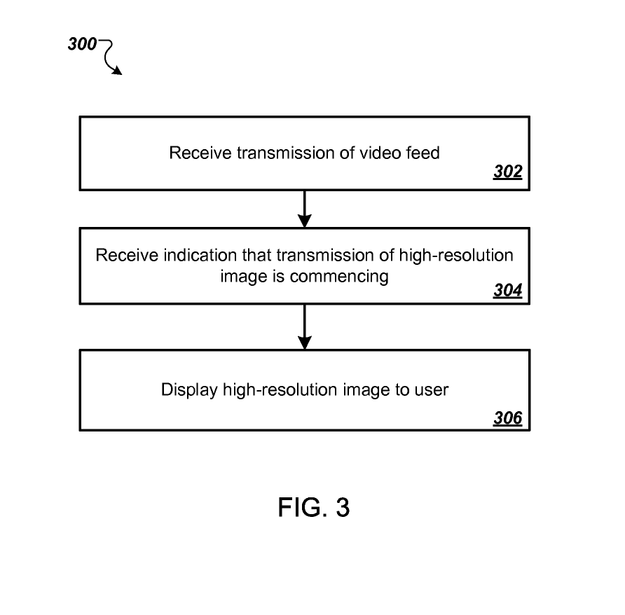

In some circumstances, one of the users participating in an interactive session may find it beneficial to view a still image, e.g., a single video frame or an image of a portion of the field of view of the video input device, that is a higher resolution than the video feed being provided to that user. Thus, in response to determining that certain criteria are satisfied, one of the user devices 130 may, while transmitting a video feed captured by a video input device to the user device of another, capture a high-resolution image using the video input device and transmit the image to the user device of the other user for presentation to the other user. Capturing and transmitting a high-resolution image is described below with reference to FIG. 2. Receiving and displaying a high-resolution image is described below with reference to FIG. 3.

FIG. 2 is a flow diagram of an example process 200 for capturing and transmitting a high-resolution image. For convenience, the process 200 will be described as being performed by a system of one or more computers located in one or more locations. For example, a user device e.g., one of the user devices 130 of FIG. 1, appropriately programmed, can perform the process 200.

The system transmits a video feed captured by a video input device from one user to another over a communication channel (step 202). For example, the video feed may be transmitted as part of an interactive session participated in by two or more users. That is, the system provides a video feed captured by the user device by the video input device for presentation to the other users that are participating in the interactive session. The video feed is a stream of data, i.e., a stream of compressed video frames, that is transmitted using bandwidth allocated to the channel. Generally, the system also transmits a corresponding audio feed with the video feed.

During the transmitting, the system determines that a criterion for providing a high-resolution image for display to the other user is satisfied (step 204). The system can determine that the criterion has been satisfied in any of a variety of ways.

For example, the system may be configured to provide a high-resolution image at predetermined time intervals. In these cases, the system determines that the criterion is satisfied each time the interval elapses.

As another example, the system may be configured to determine that the criterion is satisfied when a request for a high-resolution image, e.g., an input selecting a designated user interface element or a selection of a designated key on an input device, is received from one of the users participating in the interactive session. In some implementations, the system allows each of the users participating in the interactive session to submit an input requesting that a high-resolution image be captured. In some other implementations, the system is configured to allow only some of the users participating in the interactive session to request a high-resolution image, e.g., only the user transmitting the feed or only the users to whom the feed is being transmitted.

As another example, the system may be configured to determine that the criterion is satisfied from an analysis of the video feed as it is being transmitted. For example, the system may be configured to analyze the video frames that are being transmitted and determine that they contain insufficient detail and therefore that a high-resolution still image would be desirable. As another example, the system may be configured to determine that the video frames include written characters or other fine details. As another example, the system may be configured to analyze the video frames and determine that more than a threshold number of consecutive frames include an image of the same object, e.g., a drawing on a piece of paper or on a whiteboard. That is, if the video stream is focused on the same object for more than the threshold number of consecutive frames, the system can determine that it would be desirable to the participants of the session to provide a high-resolution image of the object. As another example, the system may be configured to determine that the criterion is satisfied if an object in the consecutive sequence of frames is moving across the scene at a sufficiently high rate of speed, i.e., so that it is likely that the object's features will not be accurately displayed due to the low resolution of the video feed.

As another example, the system may be configured to determine that the criterion is satisfied when an indication is received from an interactive session system, e.g., the interactive session system 140 of FIG. 1. That is, the interactive session system may be configured to determine when the criteria for a high-resolution image are satisfied, e.g., as described above, and, in response to determining that the criteria are satisfied, transmit an indication to the system.

In response to determining that the criterion is satisfied, the system captures the high-resolution image using the video input device (step 206). In some circumstances, the video input device may have multiple modes including a lower-resolution mode for capturing a video stream and a higher-resolution mode for capturing still images. In these circumstances, in order to capture the high-resolution image, the system can pause the video mode of the video input device and capture the image using the higher-resolution mode. Once the image has been captured, the system can resume capturing video using the lower-resolution mode.

In other circumstances, e.g., when the input device does not have a higher-resolution mode, the system can capture the high-resolution image by copying a video frame captured as part of the video feed at full resolution before the frame is compressed for transmission over the channel.

In some implementations, prior to capturing the high-resolution image, the system can allow participants in the session to identify a particular object or area that is of interest. That is, in response to receiving a request for a high-resolution image from a user, the system can present a user interface to the user that allows the user to specify an area that is of interest to the user, e.g., by allowing the user to submit an input identifying a particular portion of a recent frame of the video feed, e.g., by outlining the particular portion using a touch input or an input device. The system can then adjust the position, the zoom level, or both of the video input device to ensure that the identified area is captured in the high-resolution image or so that only the identified area is captured in the high-resolution image. Alternatively or in addition to allowing the participants to identify objects or areas of interest, the system can automatically, i.e., without requiring user input, classify particular objects or areas as being of interest. For example, the system may be configured to detect areas containing written characters or faces of people and classify those areas as being of interest. As another example, the system may be able to detect areas containing objects or other content that is similar to content previously identified as being of interest by the participants, i.e., for a previously high-resolution image captured during the session or an earlier session, and to classify those areas as being of interest.

The system transmits the high-resolution image to the other user over the channel (step 208). In some implementations, the system stops transmitting the video feed and transmits the high-resolution image over the channel using bandwidth that otherwise would have been used by the video feed. Once the high-resolution image has been transmitted, the system resumes transmitting the video feed. Optionally, the system continues to transmit an audio feed while the video feed is paused.

In some other implementations, the system transmits the high-resolution image to the other user as part of the video feed. That is, the system may decrease the quality of the video frames being transmitted in order to make more bandwidth available to transmit the high-resolution image. For example, the system can temporarily re-allocate a portion of the channel's bandwidth to transmission of the high-resolution image by reducing the amount of bandwidth allocated to the video feed. Optionally, the system transmits the high-resolution image with an indication that the image is data is not to be considered video frames by the receiving device, e.g., by tagging the data stream to indicate that the stream includes other data in addition to video frame data. Once the high-resolution image has been transmitted, the system can restore the bandwidth allocated to the video feed to its original amount.

FIG. 3 is a flow diagram of an example process 300 for displaying a high-resolution image during a video feed. For convenience, the process 300 will be described as being performed by a system of one or more computers located in one or more locations. For example, a user device, e.g., one of the user devices 130 of FIG. 1, appropriately programmed, can perform the process 300.

The system receives a transmission of a video feed and displays the video feed to the user (step 302). The video feed can be, e.g., a video feed captured by another user participating in an interactive session with the user.

While the video feed is being received, the system receives an indication that transmission of a high-resolution image is commencing (step 304). For example, the system may receive an indication that the video feed has been paused and that transmission of a high-resolution image is commencing. Optionally, when the system receives the indication that the video feed has been paused, the system can display a visual indicator that indicates to the user that the video has been paused until transmission of the high-resolution image has been resumed. Alternatively, the sending system may insert the visual indicator into the video feed before transmitting it to the system.

As another example, the system may receive an indication that part of the bandwidth allocated to the communications channel over which the video feed is being transmitted has been temporarily allocated to the high-resolution image. That is, the data stream received by the system may include data that is tagged as data that is not to be considered video data.

The system displays the high-resolution image to the user (step 306). That is, while each frame that is received as part of the video feed is generally decompressed and displayed for a specific frame time, e.g., based on the current frame rate of the video feed, the system displays the high-resolution image as a still image, i.e., for longer than the specific frame time.

The system can display the high-resolution image to the user in any of a variety of ways. For example, the image can be displayed to the user side-by-side with the video feed, e.g., in a separate window or as a picture-in-picture insert. As another example, the system can display the image in place of the video feed and, optionally, continue to play a live audio feed while the image is displayed. Optionally, the manner in which the high-resolution image is displayed to the user may be selected based on user preferences or the user may be given an option to select the manner in which the image is to be displayed once the indication that transmission of the image is about to commence is received.

While the high-resolution image is being displayed, the user may be able to interact with the displayed image in various ways, e.g., by submitting an input to pan to different portions of the image or zoom in or out. In some implementations, instead of or in addition to displaying the received image, the system can route the received image to a printer in communication with the system, e.g., so that the image is automatically printed after being received.

In some implementations, the system does not display the high-resolution image to the user until the entire image has been received, i.e., the system does not display the single image until it can be displayed in full resolution. For example, the system may refrain from displaying the data that is tagged or labeled as being high-resolution image data in the video data stream until all of the data has been received. In some other implementations, the system can display the image as it is being received, i.e., initially display the image at a low resolution and increase the resolution as additional data is received.

While the above description describes a high-resolution image being captured using the same video input device as is being used to capture a video feed that is being transmitted to other participants of an interactive session, in some implementations, a separate video input device may be used to capture the image. For example, if the user device of the user whose feed is being is transmitted includes two or more video input devices and only one is being used to capture the video feed, one of the other video input devices may be used to capture an image that can be transmitted to other participants. Additionally, while the above description describes a high-resolution image being captured by a single video input device, in some implementations, the high-resolution image that is displayed to participants of the session may be composed of images captured by multiple video input devices. For example, if the user device of the user whose feed is being is transmitted includes two or more video input devices, multiple ones of the video input device may capture the image and then a single high-resolution image.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media.

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, e.g., web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. However, a computer need not have such devices. Moreover, a computer can be embedded in another device, e.g., a mobile telephone, a smart phone, a mobile audio or video player, a game console, a Global Positioning System (GPS) receiver, and a wearable computer device, to name just a few. Devices suitable for storing computer program instructions and data include all forms of non-volatile memory, media and memory devices, including by way of example semiconductor memory devices, magnetic disks, and the like. The processor and the memory can be supplemented by, or incorporated in, special purpose logic circuitry.

To provide for interaction with a user, embodiments of the subject matter described in this specification can be implemented on a computer having a display device for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input and output.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by one or more computers, the method comprising:
transmitting a video feed captured by a first video input device from a first user to a second user over a channel;
determining, during the transmission, that criteria for capturing a high-resolution image are satisfied;
in response to determining that the criteria are satisfied, and during the transmission of the video feed, capturing the high-resolution image using the first video input device; and
transmitting the high-resolution image over the channel to the second user, wherein transmitting the high-resolution image comprises:
stopping the transmitting of the video feed,
transmitting the high-resolution image while the transmitting of the video feed is stopped, and
resuming the transmitting of the video feed.

2. The method of claim 1, wherein capturing the high-resolution image using the first video input device comprises:
copying a video frame captured by the first video input device as part of the video feed prior to the frame being compressed for transmission over the channel.

3. The method of claim 1, wherein the video feed is captured using a lower-resolution video mode of the first video input device, and wherein capturing the high-resolution image using the first video input device comprises:
pausing the video mode;
activating a higher-resolution still image mode of the video input device;
capturing the high-resolution image using the still image mode; and
resuming the video mode.

4. The method of claim 1, wherein determining that criteria for providing a high-resolution image are satisfied comprises:
determining that a predetermined time period has elapsed.

5. The method of claim 1, wherein determining that criteria for providing a high-resolution image are satisfied comprises analyzing video frames from the video feed.

6. The method of claim 1, wherein determining that criteria for providing a high-resolution image are satisfied comprises:
receiving a request for a high-resolution image from a requesting user.

7. The method of claim 6, further comprising:
in response to receiving the request, providing a user interface for display to the requesting user to enable the requesting user to specify an area of interest in a recently transmitted video frame.

8. The method of claim 1, further comprising:
receiving, at a user device of the second user and while receiving the transmitted video feed, an indication that transmission of the high-resolution image is commencing; and
displaying the high-resolution image to the second user.

9. The method of claim 8, wherein displaying the high-resolution image comprises displaying the high-resolution image while displaying the video feed.

10. A method performed by one or more computers, the method comprising:
transmitting a video feed captured by a first video input device from a first user to a second user over a channel;
determining, during the transmission, that criteria for providing a high-resolution image for display to the second user are satisfied;
in response to determining that the criteria are satisfied, and during the transmission of the video feed, capturing the high-resolution image using the first video input device; and
transmitting the high-resolution image over the channel to the second user as part of the video feed.

11. The method of claim 10, wherein capturing the high-resolution image using the first video input device comprises:
copying a video frame captured by the first video input device as part of the video feed prior to the frame being compressed for transmission over the channel.

12. The method of claim 10, wherein the video feed is captured using a lower-resolution video mode of the first video input device, and wherein capturing the high-resolution image using the first video input device comprises:
pausing the video mode;
activating a higher-resolution still image mode of the video input device;
capturing the high-resolution image using the still image mode; and
resuming the video mode.

13. The method of claim 10, wherein determining that criteria for providing a high-resolution image are satisfied comprises:
determining that a predetermined time period has elapsed.

14. The method of claim 10, wherein determining that criteria for providing a high-resolution image are satisfied comprises analyzing video frames from the video feed.

15. The method of claim 10, wherein determining that criteria for providing a high-resolution image are satisfied comprises:
receiving a request for a high-resolution image from a requesting user.

16. The method of claim 15, further comprising:
in response to receiving the request, providing a user interface for display to the requesting user to enable the requesting user to specify an area of interest in a recently transmitted video frame.

17. The method of claim 10, wherein transmitting the high-resolution image over the channel to the second user as part of the video feed comprises temporarily re-allocating a portion of a bandwidth of the channel previously allocated to the transmitting of the video feed to the transmitting of the high-resolution image.

18. The method of claim 10, further comprising:
receiving, at a user device of the second user and while receiving the transmitted video feed, an indication that transmission of the high-resolution image is commencing; and
displaying the high-resolution image to the second user.

19. The method of claim 18, wherein displaying the high-resolution image comprises displaying the high-resolution image while displaying the video feed.

20. A system comprising one or more computers and one or more storage devices storing instructions that, when executed by the one or more computers, cause the one or more computers to perform operations comprising:
transmitting a video feed captured by a first video input device from a first user to a second user over a channel;
determining, during the transmission, that criteria for capturing a high-resolution image are satisfied;
in response to determining that the criteria are satisfied, and during the transmission of the video feeds, capturing the high-resolution image using the first video input device; and
transmitting the high-resolution image over the channel to the second user, wherein transmitting the high-resolution image comprises:
stopping the transmitting of the video feed,
transmitting the high-resolution image while the transmitting of the video feed is stopped, and
resuming the transmitting of the video feed.

21. The method of claim 1, wherein determining, during the transmission, that criteria for capturing a high-resolution image are satisfied comprises:
detecting written characters in video frames from the video feed.

22. The method of claim 1, wherein determining, during the transmission, that criteria for capturing a high-resolution image are satisfied comprises:
detecting a same object in more than a threshold number of consecutive video frames from the video feed.

23. The method of claim 1, wherein determining, during the transmission, that criteria for capturing a high-resolution image are satisfied comprises:
detecting an object in consecutive video frames from the video feed moving across a scene faster than a threshold rate of speed.

24. The method of claim 1, wherein determining, during the transmission, that criteria for capturing a high-resolution image are satisfied comprises:
detecting an object that has been previously identified as being of interest by a user.

25. The method of claim 1, wherein determining, during the transmission, that criteria for capturing a high-resolution image are satisfied comprises:
presenting a user interface that allows a user to specify an area of interest in video frames from the video feed.
